(19) United States
(12) Patent Application Publication
(10) Pub. No.: US 2015/0106025 A1
(43) Pub. Date: Apr. 16, 2015

(54) Method and System for Determining and Communicating a Performance Measure Using a Performance Measurement System

(71) Applicants: Matthew Craig Keller, Barrington, IL (US); Alexis K. Park, La Habra, CA (US)

(72) Inventors: Matthew Craig Keller, Barrington, IL (US); Alexis K. Park, La Habra, CA (US)

(73) Assignee: SPORTTECH, LLC, Barrington, IL (US)

(21) Appl. No.: 14/512,218

(22) Filed: Oct. 10, 2014

Related U.S. Application Data
(60) Provisional application No. 61/889,637, filed on Oct. 11, 2013.

(51) Int. Cl. G01B 21/00; A63B 71/06

(52) U.S. Cl. CPC G01B 21/00; A63B 71/06
USPC 702/19

(57) ABSTRACT

A method implemented by a wearable performance measurement system, for determining and communicating a performance measure, includes selecting a mode of operation of the wearable performance measurement system from a plurality of configured modes of operations. Each mode of operation has a corresponding configured performance measure and configured feedback technique. At least one of the configured performance measure or the configured feedback technique is different for each mode of operation. The method also includes using a set of sensors of the wearable performance measurement system to detect at least one physical movement of a person. The method further includes, determining a type of physical activity from the at least one detected physical movement, and determining a performance measure corresponding to the selected mode of operation. The method also includes communicating an indication of the determined performance measure using the feedback technique corresponding to the selected mode of operation.

### RELATED APPLICATIONS

The present application is related to and claims benefit under 35 U.S.C. §119(e) from U.S. Provisional Patent Application Ser. No. 61/889,637 filed Oct. 11, 2013, the entire contents of which is incorporated herein by reference.

### FIELD OF THE DISCLOSURE

The present disclosure relates to an exercise performance measurement system for communicating exercise performance measures, and more particularly to a wearable performance measurement system for determining and communicating a performance measure.

### BACKGROUND

Athletes have an interest in receiving feedback on performance measures during and after a workout. As athletes execute a workout, a coach may monitor their performance and exhort them by communicating different performance measures to the athlete. In the case of swimming, a coach's communications are hindered by the noise of splashing water and swimming motions that require the athlete to submerge his head in the water. When this occurs, the athlete's ability to hear different performance measures is compromised, and the reliable communication of performance feedback has to wait until after the workout is completed.

After a workout is completed, the athlete often wants to view and analyze performance data associated with the workout. The ability to view workout information in various formats aids the athlete in understanding areas where improvement is needed and areas where the athlete is performing well. Recreational athletes often times want to share and compare their results with other people of similar age and ability. Regardless of the competitive level of the athlete, the athlete often wants to view, plan, and track future workouts.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of those embodiments.

FIG. 1 is a schematic diagram of an example environment within which may be implemented methods and a device for determining and communicating a performance measure by a performance measurement system in accordance with the present teachings.

FIG. 2 is a block diagram showing example components of a performance measurement system in accordance with the present teachings.

FIG. 3 illustrates a person wearing an embodiment of a performance measurement system for determining and communicating a performance measure in accordance with the present teachings.

FIG. 4 is a flow diagram illustrating an embodiment of a method, performed by a swimming performance measurement system, for determining and communicating a swimming performance measure in accordance with the present teachings.

FIG. 5 illustrates an example tabular view of exercise data that is viewable and updatable using an electronic device or computing device in accordance with the present teachings.

FIG. 6 illustrates calendar and tabular views of workouts displayable on an electronic device or computing device in accordance with the present teachings.

FIG. 7 illustrates a tabular view of workouts displayable on an electronic device or computing device in accordance with the present teachings.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure. In addition, the description and drawings do not necessarily require the order illustrated. It will be further appreciated that certain actions and/or steps may be described or depicted in a particular order of occurrence while those skilled in the art will understand that such specificity with respect to sequence is not actually required.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Generally speaking, pursuant to the various embodiments, a method implemented by a wearable performance measurement system, for determining and communicating a performance measure, includes selecting a mode of operation of the wearable performance measurement system from a plurality of configured modes of operations. Each mode of operation of the plurality of configured modes of operation has a corresponding configured performance measure and configured feedback technique, and at least one of the configured performance measure or the configured feedback technique is different for each mode of operation. The method also includes detecting, using a set of sensors of the wearable performance measurement system, at least one physical movement of a person. Additionally, the method includes determining a type of physical activity from the at least one detected physical movement. Also included in the method is determining the performance measure corresponding to the selected mode of operation, wherein the determining is based on the at least one detected physical movement and the type of physical activity. Additionally, an indication of the determined performance measure is communicated using the feedback technique corresponding to the selected mode of operation.

In another embodiment a wearable performance measurement system for determining and communicating a performance measure includes a set of sensors configured to detect at least one physical movement of a person, and a processor coupled to the set of sensors. The processor is configured to select a mode of operation of the wearable performance measurement system from a plurality of configured modes of operations, wherein each mode of operation of the plurality of configured modes of operation has a corresponding configured performance measure and configured feedback technique, and at least one of the configured performance measure or the configured feedback technique is different for each mode of operation. The processor is further configured to receive, from the set of sensors, an indication of the at least one detected physical movement. The processor is also configured to determine a type of physical activity from the at least one detected physical movement. Additionally, the processor is configured to determine the performance measure corresponding to the selected mode of operation, wherein the determining is based on the at least one detected physical movement and the type of physical activity. An output component coupled to the processor is also included in the wearable performance measurement system. The output component is configured to communicate an indication of the performance measure using the feedback technique corresponding to the selected mode of operation, wherein selecting the mode of operation, detecting the at least one physical movement, determining the type of physical activity, determining the performance measure, and communicating the indication of the performance measure is performed multiple times over a time period during a same physical activity session, wherein at least two different modes of operation are selected during the time period.

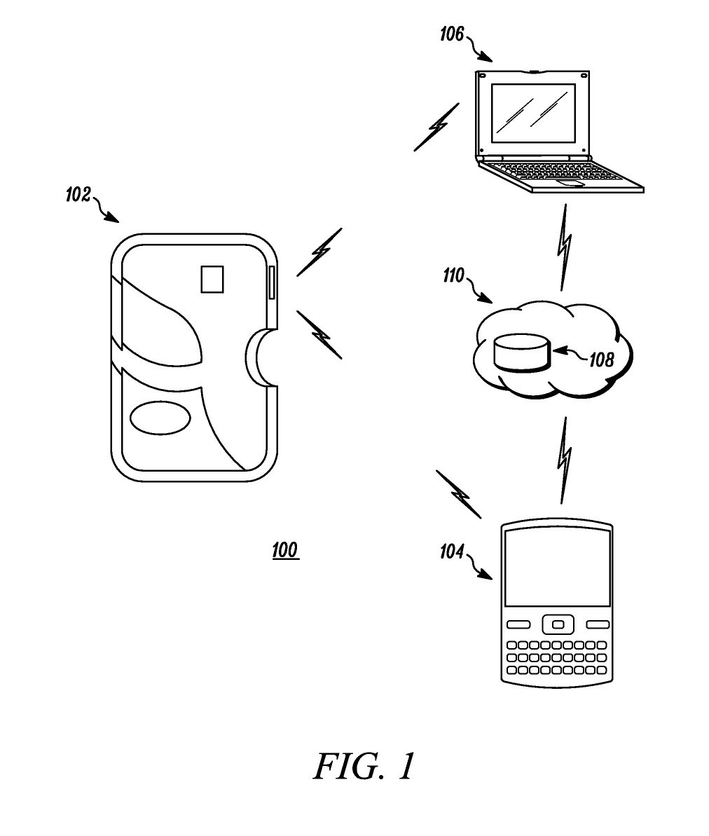

Referring to the drawings and in particular to FIG. 1, illustrated therein is a schematic diagram of an example environment 100 within which may be implemented methods and a device for determining and communicating a performance measure. As shown, the environment 100 includes a wearable performance measurement system 102, an electronic device 104, a computing device 106, and a database 108 within a network 110, such as the Internet. The wearable performance measurement system 102 is configured to communicate with the electronic device 104 and the computing device 106. The electronic device 104 and the computing device 106 are further configured to communicate with the database 108, for instance a server, in the network 110. In one example, such communications are performed using wireless connections, such as Bluetooth, Wireless Fidelity, Zigbee, etc., connections. In another example, such communications are performed using wired connections, such as Ethernet, Universal Serial Bus USB, Firewire, etc., connections. The electronic device 104 can be implemented as a Smartphone, a personal media player, a cell phone, personal digital assistant, etc. Whereas, the computing device 106 can be implemented as a laptop, a desktop, a tablet, a phablet, and the like.

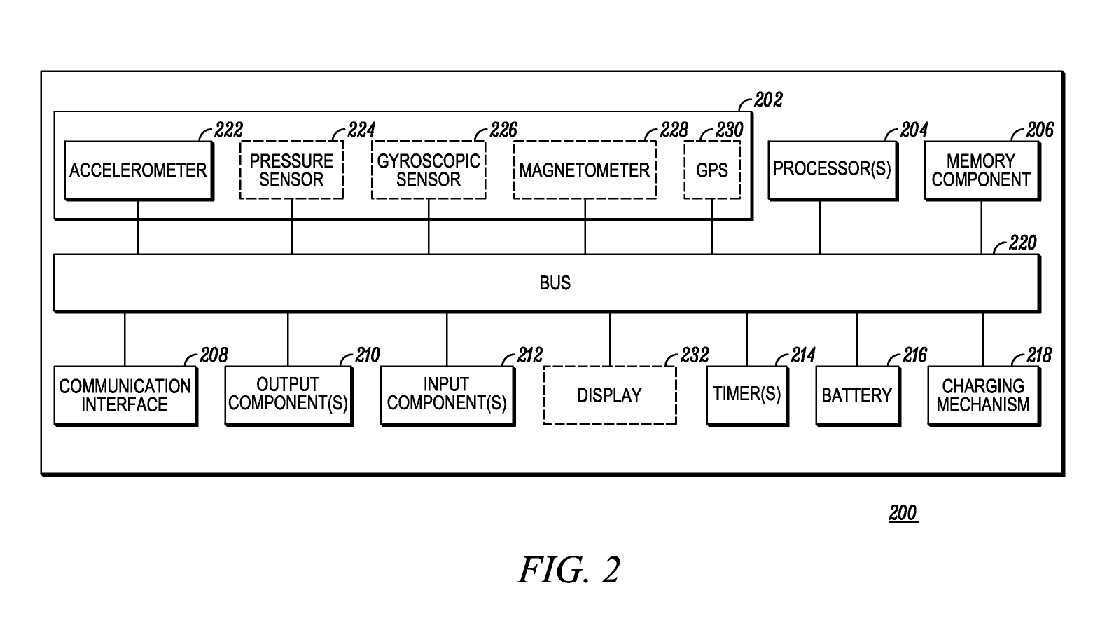

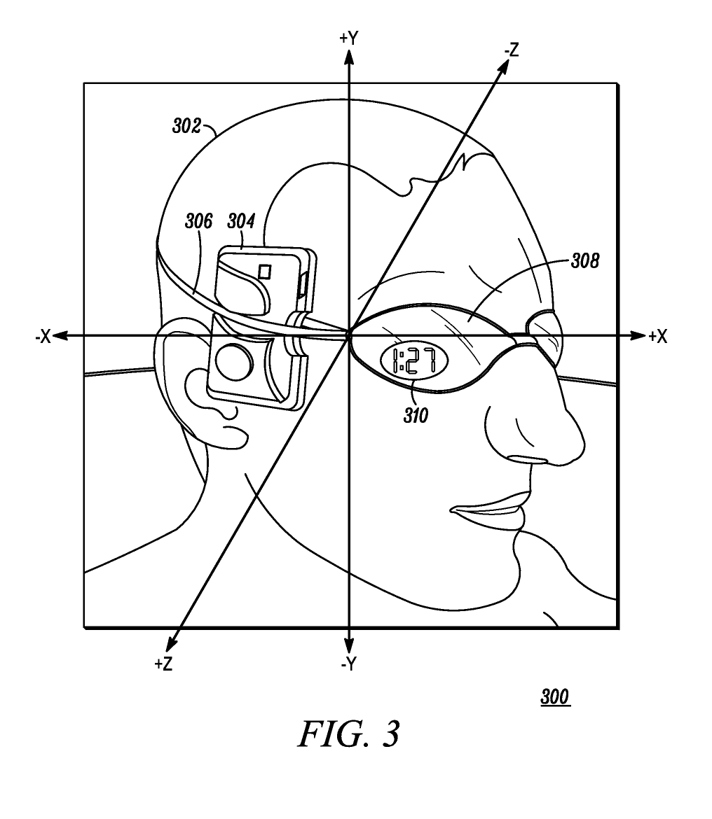

FIG. 2 is a block diagram illustrating example internal components 200 of a wearable performance measurement system for determining and communicating a performance measure in accordance with the present teachings. As shown in FIG. 2, the internal components 200 include a set of sensors 202, one or more processors 204, a memory component 206, a communication interface 208, output one or more components 210, one or more input components 212, a display 232, one or more timers 214, a battery 216, and a charging mechanism 218. The sensors 202 include an accelerometer 222. Optionally, the set of sensors 202 also include a pressure sensor 224, a gyroscopic sensor 226, a magnetometer 228, and a global positioning system (GPS) 230. As further illustrated the internal components 200 are coupled with one another, and in communication with one another, by way of one or more internal communication links 220, for instance an internal bus. Alternatively, one or more of the sensors 202 are positioned on remote locations (e.g., wrist, arm, ankle, leg, etc.) of the user's body and the communication interface 208 is used to communicate wirelessly or via a wired connection with the remote sensors 202. The processor 204 is coupled to the set of sensors 202, the output component(s) 210, the input component(s) 212, and the memory component 206 to carry out functionality in accordance with the present teachings. The performance measurement system also includes a housing (not shown in FIG. 2 but shown in FIG. 1 and FIG. 3) that contains the set of sensors 202, the processor 204, the output component 210 and the rest of the internal components 200. For example, the housing is used to protect the internal components 200 from impact damage and provide a waterproof enclosure for the internal components 200 of the system 102. Moreover, in at least one embodiment, the housing is configured to be worn by a person. Other elements needed for a commercial embodiment of a device that incorporates the components shown at 200 are omitted from FIG. 2 for clarity in describing the enclosed embodiments.

The accelerometer 222 is configured to sense a user's motion in various directions in three-dimensional spaces. For example, the accelerometer 222 senses a rate of change in velocity of all three axes/directions (i.e., X, Y, and Z, see FIG. 3) and generates the X, Y, and Z values while experiencing any type of non-constant movement. The X, Y, and Z accelerometer data are sampled at a particular interval or frequency, the results of which are communicated to the processor 204. The pressure sensor 224 is configured to detect an atmospheric change in pressures, such as water pressure. Accordingly, the pressure sensor 224 can to detect pressure changes attributable to how deep the system 102 is in water or whether the system is out of the water. The gyroscopic sensor 226 measures the rate of change of roll (rotation about the X axis), pitch (rotation about the Y axis) and yaw (rotation about the Z axis). The magnetometer 228 provides a compass direction that is translatable to direction in the X-Y plane. The GPS 230 enables the determination of a geographic location of the system 102.

As a person engages in a workout, which is a physical activity session that includes a series or sequence of physical activities, the set of sensors 202 determines physical movement of the person and communicates an indication of the physical movement to the processor 204. The processor 204 is configured to use these elements 200, as described herein, to determine a performance measure based on a selected mode of operation of the performance measurement system 102. In particular, the processor 204 is configured to select a mode of operation of the wearable performance measurement system 102 from a plurality of configured modes of operations, wherein each mode of operation of the plurality of configured modes of operation has a corresponding configured performance measure and configured feedback technique, and at least one of the configured performance measure or the configured feedback technique is different for each mode of operation. The feedback technique includes a way that the system 102 provides feedback. For example, one feedback technique is an audible announcement provided by way of a feedback announcement. Another feedback technique is a message displayed by way of the display 232. A mode of operation is a discrete operating state of the system 102 which includes associated characteristics, such as, a corresponding configured performance measure, a corresponding configured feedback technique, and a corresponding set of sensors for detecting at least one physical movement which is based on the performance measure. A configured parameter, such as a mode of operation or feedback technique, is a parameter resident in memory 206 and/or the processor 204 before executing the method 400. The parameter is illustratively downloaded to the system 102 from the device 106, 104 or configured into the system 102 as part of manufacture.

Because at least one of the configured performance measure or the configured feedback technique is different for each mode of operation, no two configured modes of operation are the same. The processor 204 receives, from the set of sensors 202, an indication of the at least one detected physical movement, determines a type of physical activity from the at least one detected physical movement, and determines a performance measure corresponding to a selected mode of operation, wherein the determining is based on the at least one detected physical movement and the type of physical activity. Example implementations of the processor 204 include a microprocessor, a microcomputer, application-specific integrated circuit, and the like.

The memory component 206 in various embodiments can include one or more of: volatile memory elements, such as random access memory (RAM); or non-volatile memory elements, such as a flash memory. The memory component 206 is configured to store information that enables the processor 204 to determine a performance measure. In one example the memory component 206 stores swimming information (e.g., workout plans, modes of operation, etc.) as well as detected sensor data and determined performance measures. The memory component 206 is illustratively coupled to the processor 204 and configured to store a workout plan used for automatically selecting modes of operation from a plurality of modes of operation. The memory component 206 is also configured to store the plurality of modes of operation that are selectable in accordance with disclosed embodiments.

The communication interface 208 enables the system 102 to communicate with external devices, for instance the electronic device 104 and the computing device 106, to configure, update, and download workout plans to the system 102. The communication interface 208 is one or more wired and/or wireless interfaces capable of communicating using various protocols, such as, Bluetooth, Wireless Fidelity (WiFi), Ethernet, Universal Serial Bus (USB), Firewire, and the like.

The system 102 includes output component(s) 210 configured to communicate an indication of the performance measure, for instance a swimming performance measure, determined by the one or more processors 204. The indication of the performance measure is communicated using a feedback technique corresponding to a selected mode of operation of the wearable performance measurement device. In one example, the output component 210 is an audio output component, such as a speaker, earphones, earbuds, ear speakers, a headphone, etc. In another example, the output component(s) 210 includes a visual component that is integrated into a device, such as goggles, a wristwatch, etc., worn by the user and coupled to or incorporating the wearable performance measurement system 102.

In one embodiment the feedback technique is an audio feedback technique, and the audio feedback technique is a feedback announcement. For example, the feedback technique is an audio message communicated via the output component 210 using a speaker, a headphone(s), earpiece, or a bone conduction transducer. Additionally, the feedback announcement is a particular message, for example, a measured time of “one oh four point six.” Accordingly, the audio output component 210 is configured to communicate the indication of the performance measure using the feedback announcement. In another embodiment, the audio feedback technique is a beep or other tone used to communicate the indication of the performance measure via the audio output component. In one implementation, one lap measured translates to one beep, two laps measured translates to two beeps, etc. The audio output component 210 can also be used to communicate other audio feedback announcement including, but not limited to, communicating the current mode of operation or a segment of the current mode of operation or workout plan identification information.

A user interacts with the system 102 through the input component(s) 212. For example, a person interacting with the system 102 uses an input component 212 to switch between modes of operation, start and stop the timer(s) 214, select a workout plan, as well as other operations. In one particular example the input component 212 is coupled to the processor 204 and configured to receive a user input for selecting a mode of operation, of the system 102, from a plurality of modes of operation. Illustratively, the one or more input components 212 contain at least one switches, button, touch control or panel, and/or dial configured to receive tactile inputs from the user. In other embodiments, the input component 212 includes a set of sensors configured to detect user taps and tactile gestures to the system 102. In this manner, the user can send commands to the system 102 via the input component 212 using one or more taps, which the accelerometer 222 detects as an impulse spikes. In still another embodiment, the one or more input components 212 include a voice interface configured to receive voice inputs that the processor 204 interprets.

The system 102 also includes one or more timers 214 configured to simultaneously or serially time any number of different events. The battery 216 powers the other internal components 200 to enable their functionality. Also, included among the elements 200 is a charging mechanism 218 for charging the battery.

FIG. 3 is an illustration 300 of a person 302 wearing one embodiment of a wearable performance measurement system, such as the system 102, for determining and communicating a performance measure. FIG. 3 illustrates the person 302 wearing the system 102 contained in a housing 304 for engaging in a swimming activity. However, in other scenarios, the system 102 is worn while the person is performing other types of physical activity or sports such as walking, running, biking, skiing, weight lifting, etc. Accordingly, in the FIG. 3 embodiment, the wearable performance measurement system is a wearable performance measurement system that determines and communicates performance measures. However, in other embodiments, the wearable performance measurement system can determine and communicate performance measures for swimming and other physical activities or sports such as those listed above.

In the embodiment shown in FIG. 3, the housing 304 is configured to be coupled to a pair of swimming goggles 308. For example, the housing 304 of the system 102 includes a clip, clasp, hasp, hook, and/or buckle to attach the system 102 a strap of the goggles 308. Alternatively, the housing 304 is fully integrated into the goggle strap. The system 102 is secured to a strap 306 of swimming goggles and held to a side of the head of the person 302. The position of the system 102 illustrated in FIG. 3 is one possible position of the device. In other embodiments the system 102 is secured to another part of the user's 302 body, such as the waist, back, neck, etc., which follows a primary direction of travel of a swimmer.

The system 102 senses motion in a three-dimensional space represented by the three axis (i.e., X, Y, Z) that is interposed on the illustration depicted in FIG. 3. As referred to herein, the X and Z directions are perpendicular to the direction of gravity, and the Y direction is parallel to the direction of gravity. In relation to the head/body in an upright position, forward motion is measured on the X axis, up and down motion is measured on the Y axis, and side to side motion is measured on the Z axis. The device 102 is also configured to measure pitch, roll and yaw, where pitch is rotation about the Z-axis, yaw is rotation about the Y-axis, and roll is rotation about the X-axis. In other embodiments, there is a second X, Y, Z coordinate system relative to the system 102, that is, relative to what the system sensors 202 sense. When there is a second coordinate system a mapping is performed between the two coordinate systems to determine some performance measures, such as, velocity. For other performance measures, it is sufficient to sense indications of physical movement relative to the system 102.

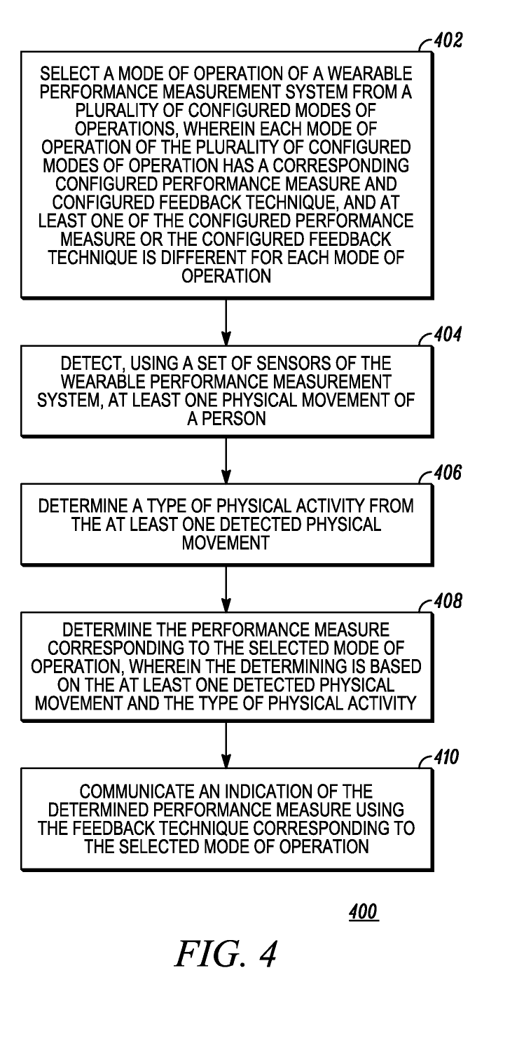

As a user engages in various physical activities, the system 102 detects physical movement of the person in relation to the X, Y and Z axes. The system 102 interprets the physical movement or combination of detected physical movements to determine a physical activity and performance measure based on a mode of operation of the system 102. FIG. 4 is a flow diagram illustrating a method 400, performed by the wearable performance measurement system 102, for determining and communicating a performance measure in accordance with the teachings herein. In one example, the method 400 is performed by a wearable performance measurement system, such as the one illustrated in FIG. 1 and FIG. 3. Accordingly, the functionality illustrated by the method 400 can be described in the context of the sport of swimming, wherein determining the type of physical activity includes determining a type of swimming activity and determining the performance measure includes determining a swimming performance measure based on the type of swimming activity. In the context of swimming, swimming activities include physical activities performed while swimming. Example types of swimming activities include different swimming strokes such as front crawl or a backstroke, a turn, a start event, a stop event, etc. Physical movements of the arms, head, and/or legs, as detected by the sensors 202 can be used in an algorithm to determine that the type of physical activity is a type of swimming activity, such as one of the types of swimming activities mentioned above.

A swimming performance measure includes a distance swum of a workout segment, a distance remaining of a workout segment, a number of laps (a distance from one end of the pool to the other end) completed in a workout segment, a number of laps remaining in a workout segment, an aggregate time, a computed time, a target time (e.g., any predetermined time interval) of an interval, segment, and/or workout, stroke cadence (i.e., strokes per unit of time, such as a minute), a stroke technique evaluation, velocity, change in velocity, etc. A workout is based on a workout plan. A workout plan, and in general a workout, can be broken into one or more parts referred to herein as segments or workout segments. As relates to swimming and/or other sports, a segment can include one or more intervals, also known as sets, which include short periods of exercise that are optionally interspersed with rest periods.

In one particular embodiment, operation of the system 102 includes selecting 402 a mode of operation of the system 102 from a plurality of configured modes of operations, wherein each mode of operation of the plurality of configured modes of operation has a corresponding configured performance measure and configured feedback technique, and at least one of the configured performance measure or the configured feedback technique is different for each mode of operation. Having at least one one of the configured performance measure or the configured feedback technique different for each mode of operation means that no two configured modes of operation are the same.

Optionally, the mode of operation is selected based on manual input received into the input component 212 of the wearable swimming performance measurement system 102. Manual input involves the user tapping, double tapping the system 102, or manipulating one or more switches, dials, or touch sensitive input components to provide an input via the input component 212. The mode of operation is also automatically selectable. In one example scenario, to automatically select a mode of operation the user downloads the system 102 with one or more modes of operation, and the mode of operation is automatically selected, illustratively by the processor 204, based on a workout plan.

A workout plan, in one example, includes a plurality of segments, and the selecting the mode of operation, the detecting the at least one physical movement, the determining the type of physical activity, the determining the performance measure, and the communicating the indication of the performance measure is correspondingly performed for multiple segments of the plurality of segments. Multiple segments could be all the segments, or less than all the segments. In one particular example, selecting the mode of operation for the multiple segments of the plurality of segments includes selecting a first mode of operation for a first segment and selecting a different second mode of operation for a second segment. In one embodiment, a feedback announcement is illustratively used to communicate an indication of a beginning of at least some of the segments of the workout plan.

As the user exercises, the system 102 detects 404, using the set of sensors 222 of the wearable performance measurement system 102, at least one physical movement of the person (user). In one particular embodiment, the set of sensors 202 for detecting the at least one physical movement is selected based on the selected mode of operation. Additionally a set of algorithms are selected or modified based on the selected mode of operation, wherein the performance measure is determined and the detecting is performed using the set of algorithms. Illustratively, threshold parameters, timing windows, filter parameters and other values used in detecting the at least one physical movement are modified depending on the selected mode of operation. For example, if the mode of operation requires detection of an up and down movement of the head (bobbing), the algorithm is modified to better detect bobbing.

The system 102 is also configured to determine 406 a type of physical activity from the at least one detected physical movement. Additionally, the system 102 is configured to determine 408 a performance measure corresponding to the selected mode of operation, wherein the determining is based on the at least one detected physical movement and the type of physical activity. In one example, the processor 204 is configured to determine a type of swimming activity from the at least one physical movement, and the processor 204 is further configured to determine the performance measure as a swimming performance measure based on the swimming activity.

To inform the user of the performance measure, an indication of the determined performance measure is communicated 410 using the feedback technique corresponding to the selected mode of operation. In one example, the indication of the performance measure is communicated before a physical activity session, which includes the at least one physical movement detected by the set of sensors 202, has terminated. Illustratively, a physical activity session has a beginning and an end. Further, the activity session could be a structured workout that is downloaded to the system or a sequence of movements having a beginning and an end, such as some type of exercise session. A physical activity session is terminated when the person ceases any physical movement that is associated with the activity session. For example, if an activity session includes swimming two laps of a pool, once physical movement directed toward swimming the two laps has completed, the activity session is terminated.

Additionally, in one example of the method 400, selecting 402 the mode of operation, detecting 404 at least one physical movement, determining 406 the type of physical activity, determining 408 the performance measure, and the communicating 410 the indication of the performance measure is performed multiple times over a time period during a same physical activity session, wherein at least two different modes of operation are selected during the time period.

The feedback technique, for example, includes a feedback announcement that is determined based on the selected mode of operation. Feedback announcements can be turned on and off based on information contained in the workout plan. For example, a user may wish to hear their splits only when doing a swim that requires negative splitting or may wish to turn off feedback announcements during warm-up sets. The device can provide the user with additional feedback announcements that are not related specifically to the mode of operation. Specific feedback announcements are illustratively pre-configured in the workout plan to be communicated when that segment of the workout plan is executed. For example, a feedback announcement encouraging the user to swim faster can be configured to be communicated during a final swim of a set.

In another example, a feedback announcement reminding the swimmer to work on a particular swim technique improvement can be communicated during a set or the goal of the set could be communicated before the set. In yet another example, swimming performance information such as a particular time for an interval or distance from another swimmer who has already performed the same workout plan and with whom this swimmer wants to compete may be communicated. The feedback announcement can also be based on calculated information from captured swimming performance information. For example, if the swimmer desires to negative split a swim, whether the negative split was achieved or by how much can be calculated and announced to the swimmer. A split is a time taken to complete a portion of a segment or interval. The total time is a time taken to complete a full workout segment (e.g., complete an interval or workout). Other statistics can be calculated as well. The system 102 is also configured to provide the feedback announcement randomly or based on a sequence of events that are unbeknownst to the user. This is based on the Easter egg concept in computer programs and can add an element of surprise for the user.

Feedback information that is communicated to users convey a variety of content including workout plan information, performance information, cadence tones, start/stop tones, as well as other information. Feedback that is communicated to the user to convey this content comes from a variety of sources including audio speech segments downloaded with a workout plan, preconfigured segments that reside on the system 102, and text to speech generated segments. To provide a user with a complete audio message, the individual audio segments are concatenated and played out to the user. The individual segments can be joined together and smoothed so that the transition between audio segments provides for more natural playback.

As the user engages in various physical movements, the system 102 is configured to determine a type of physical activity as a type of swimming activity, for example, one or more swimming events. A swimming event includes a stop event, a start event, an open turn, and a flip turn, etc. A start event is associated with a change in the user's body position from a vertical position to a horizontal position as he/she pushes off a wall or jumps or dives into the pool to start swimming. This motion results in a particular signature of sensor data that can be detected based on the similarity to a known signature of sensor data. Similarity can be determined, for example, by determining a covariance of the detected sensor data with the signature data and determining if the covariance is greater than a configured threshold.

One algorithm for detecting a start event for strokes performed on the swimmer's front (e.g., freestyle, butterfly, breaststroke, and the like) includes using the accelerometer 222 to measure acceleration changes in the X, Y, and Z axes. For example, a possible start event is indicated if an accelerometer 222 sample in the X-axis indicates a local maxima and the local maxima value is greater than a threshold. The local maxima is illustratively compared against an amount of change in the X samples (for example using the standard deviation, the variance, or other statistical methods) from a prior given period. If the amount of change in the X-axis is less than a given threshold this indicates that the local maxima in the X-axis indicates a start event. If a start event has not already been detected within a number of samples or a time window, this is also an indication that the detected local maxima is a start event.

Detecting a start event for strokes performed on the swimmer's back (e.g., backstroke) includes determining if an X sample is a local minima and whether the X sample is less than a given threshold. If a measure of the amount of change (for example using the standard deviation, the variance, or other statistical methods) in the X samples or averaged X & Z samples from a prior given period of time is less than a given threshold for variance, then the detected local minima is likely a start event. Further, if a start event was not already detected within some number of samples or some time window, this is also an indication that the detected local minima is a start event. Optionally, the swimmer manually indicates a start event, e.g. by tapping the device or pressing a button.

When stopped, swimmers change from a horizontal position to a vertical position. This results in a change in the orientation of the system 102 and swimmer's body/head changing from horizontal to vertical position. Additionally the swimmer changes from executing a series of aperiodic movements to a more stationary state with a lack of coordinated movements. A stop event is detected when the auto-covariance of a set of sensor data (e.g. the X, Y, and Z accelerometer sensor data) for a given second and a set of sensor data captured some time ago (e.g. one second) has a value greater than a configured threshold. Optionally, the user manually indicates a stop event, e.g. by tapping the device or pressing a button.

The system 102 detects a rest period as, for example, the time between a stop event and a start event. The detection of a rest period is illustratively limited to times between intervals of a set. In other embodiments, the rest period between both intervals and sets are tracked. Alternatively, the user manually indicates the completion of a set, or a start of a next set which enables the system 102 to know if the time after a stop event should be counted as a rest period.

A turn event (e.g., tumble or flip turn) occurs when the swimmer tumbles or rolls over towards the wall in a summersault type of action in order to change direction and continue swimming. This type of turn is generally used during freestyle or backstroke swimming. Turn events are detected when an X sample is a local maxima and the Y sample is a local maxima, and a turn event was not already detected within some number of samples or some time window.

An open turn event occurs when when the swimmer reaches the wall and spins around in order to change direction and continue swimming. This type of turn is generally used during butterfly and breaststroke swimming. An open turn is detected when an X sample is a local maxima and the Z sample is a local maxima, and a turn event was not already detected within some number of samples or some time window. In another embodiment sensor data from the magnetometer can be used to determine that the swimmer is now moving in a different direction, i.e. a turn has taken place.

The system 102 is also configured to determine other swimming activities such as stroke counts, stroke types, up and down body movement stroke technique, when a length of a pool is swum, and a rest time. The number of strokes or stroke cycles that a swimmer takes within given time period or for a length of pool is determined by detecting and counting individual stroke cycles. Each of the competitive strokes (butterfly, backstroke, breaststroke, and freestyle) are cyclical in nature with the same motion repeated for each stroke cycle. The periodic pattern of the stroke cycle can be detected from the 3 axis accelerometer 222 data as well as the data from the optional sensors 224, 226, 228, 230, and each initiation of a new cycle can be counted to determine stroke count information.

The system 102 can detect up and down movement by looking for periodic positive and negative values in the Y accelerometer 222 and the optional sensor 224, 226, 228, 230 data. The area under a curve formed by the Y data plotted on a time axis indicates the amount of up and down movement of the swimmer (note that for negative Y data, the absolute value should be taken to avoid cancelling out the positive Y data). Based on the size of the area, a tone of different volume and/or pitch can be communicated as a feedback announcement to the user where the tone could continually vary as new values are calculated (e.g. a higher volume or higher pitch tone for a bigger area).

The system 102 can detect head/body rotation by looking for periodic positive and negative values in the X accelerometer 222 data and the X data from the other sensors 224, 226, 228, 230. A rolling average of the area under a curve formed by the X data plotted on a time axis indicates the amount of up and down movement of the swimmer (note that for negative X data, the absolute value should be taken to avoid cancelling out the positive X data). In one embodiment, a baseline value of an expected amount of rotation can be subtracted off to determine the amount of over or under rotation. Based on the value calculated above, a tone of different volume and/or pitch can be played out to the user where the tone could continually vary as new values are calculated; a different tone pitch can be played out for positive versus negative values (e.g. a higher volume or higher pitch tone for a higher value).

The system 102 is also configured to detect when a start event is followed by a turn event, a start event is followed by a stop event, and a turn event is followed by a stop event. The system 102 is able to determine when a length of the pool is completed, and determine the time to swim the length of the pool by starting a timer when the first event is detected and stopping the timer when the second event is detected. A rest time is determined by starting a timer when a stop event is detected and stopping the timer when the next start event is detected.

Determining a total time for an interval includes determining when a stop event occurs or a user manually indicates stop. In one embodiment, the device adds up the times for all of the lengths completed since the last start event occurred. In another embodiment, a timer is started at the beginning of the interval and the timer is stopped when the stop event occurs.

Detecting a total time of a workout includes detecting a workout start event and a workout end event. The start of a workout is determined, for example, by the first start event being detected after power on, or the workout start event is determined through a manual indication. In one embodiment, the end of the workout is determined by the lack of detected swimming events for a given period of time, or the end of the workout is determined by the power down of the device (either due to a user powering it down via the on/off button or due to a lack of detected activity). In yet another embodiment, the user explicitly manually indicates the end of the workout.

In alternate embodiments, information from one or more of the optional sensors 224, 226, 228, 230 is used in conjunction with the accelerometer 222 data to confirm detected events. Illustratively, the detection of a swimming event is based on a selected mode of operation that includes a flip turn. Because a flip turn involves the swimmer pushing a depth into the water and the twisting and turning of the swimmer's head/body, the processor 204 optionally selects algorithms and sensor(s) 202 which most readily detect these motions. For example, the processor 204 selects the pressure sensor 224, the gyroscopic sensor 226 and the magnetometer 228 to detect a flip turn.

If the accelerometer 222 detects a flip turn, the processor 204 is configured to confirm this based on indication from, for example, the gyroscopic sensor 226, and the magnetometer 228. The pressure sensor should indicate a change in pressure during the flip turn when the swimmer goes deeper into the water during the turn. The gyroscopic sensor 226 will show a change in the pitch, yaw and/or roll of the swimmer's head/body as the swimmer executes the turn. At completion of the turn, the magnetometer 228 will show that the swimmer has changed directions. With this information, it is possible to confirm the accelerometer's determination of whether and what type of swimming event has occurred. During open-air swimming, the GPS 230 is available to confirm rough estimates of where a swimmer is currently swimming (e.g., middle of the pool versus at one of the ends of the pool).

The system 102 is also configurable to detect customized swimming metrics. Customized performance metrics create a simplified understanding of an exercise segment. These metrics are created by aggregating performance information including swimming events over the course of an workout segment. An example customized performance metric is an amount or consistency of negative split on an interval or set of intervals. A negative split occurs when the second half of the interval is performed at a faster time or higher effort (e.g. more weight or resistance) than the first half. Another example customized performance metric is descending. This means that the interval performance improves on each successive interval performed. A customized performance metric can be provided which indicates the amount or consistency of descending on a set of intervals.

Consistency of times within a set of intervals could serve as another customized performance metric. Training for many types of events requires consistent performance over time. A metric which indicates the amount of consistency between intervals in a set illustratively serves as such a performance metric. Consistency of times within a set or compared to a target value could be checked. Often, performance relative to a threshold pace such as anaerobic threshold is important for the quality of training. A metric which indicates the amount of consistency compared to a target value is another example performance metric. Building speed within an interval is often desirable. This means that the time to perform subsequent lengths or groups of lengths of an interval should decrease. The amount or consistency of building on an interval or set of intervals serves as one type of performance metric. Another example of customized performance metric includes technique measurements (as described below) with a score and a summary value provided over the course of an interval, set, or workout.

The entire workout can be assigned a value based on the level of intensity, which serves as a customized performance metric. Level of intensity can be personalized where intervals are compared to the user's historical times (generally lower rest equals higher intensity). Additionally how the intervals are to be performed (i.e. fast, hard, etc.) is considered. Weight or resistance used could be considered. Lastly distance or number of repetitions can be considered (more distance/repetition equals higher intensity). Each of these performance metrics are user configured or part of a workout plan. Parameters that are user configured are those that the user manually selects, have been downloaded to the system 102, or are configured in the system 102. Parameters that are part of a workout plan are, for example, derived from the workout plan, automatically selected from the workout plan, or calculated from a workout plan.

Modes of operation of the system are illustratively user configured or part of a workout plan that is user configured. The user, for example, configures the system 102 with one or more modes of operation, and as the user performs a workout, the system 102 operates in one or more of these modes of operation. A feedback technique corresponding with the mode of operation includes a feedback announcement of the swimming performance measure. Example swimming performance measures include splits, total time, elapsed time, stroke count information, stroke rate information, and customized performance metrics. Thus, for example, when the system 102 detects user physical movement indicating a turn event the system 102 announces a split time, or when the system 102 detects a stop event the system 102 announces an aggregate time for the workout segment.

In another embodiment, the feedback announcement includes elapsed time at approximately the halfway point of a length. The halfway point is illustratively calculated based on previously measured times (e.g. the prior interval), based on target time, based on a typical time for the interval distance, etc. Alternatively, instead of elapsed time, a tone such as a beep serves as a feedback announcement indicating when the swimmer is at the halfway point. The swimming events and associated feedback announcements (e.g., announce a split time when a summersault turn is detected) are user configured or part of a workout plan. Additionally, in some example scenarios, one or more of the optional sensors 224, 226, 228, 230 are selected to detect the various swimming events associated with the swimming performance measure of this mode of operation.

A multi-timer mode serves as another mode of operation of the system 102. In this mode, one or more timers 214 are used to provide various durations of a particular physical movement. The one or more timers 214 are able to repeat timing the particular movement a given number of times. In an example scenario, a first timer is configured to time a duration the physical movement associated with an active portion of a workout (e.g., the times between a start and stop event), and a second timer is configured to time a duration of physical movement associated with a rest (e.g., times between a stop and start event). The first and second timers are able to continue timing the duration of each subsequent active portion and rest during that particular workout. The different physical movements that the multiple timers 214 track of this mode of operation are user configured or part of a workout plan. Additionally, the computed times for the events such as the active portion rest event, etc. serve as a swimming performance measure associated with this mode of operation. The tracked events are based on a workout plan, or the user manually selects the events to track. The user is also able to manually start, stop, or reset the one or more timers 214 in this mode of operation. The system 102 communicates a feedback technique (e.g., an audio feedback announcement) associated with this mode of operation at the beginning and end of each event. Instructions as to an activity to perform (e.g., swim, rest, etc.) and/or how to perform the activity (e.g., high intensity, number of repetitions) also illustratively serve as a feedback technique. In some scenarios, optional sensors 224, 226, 228, 230 associated with this mode are selected to detect the various timed swimming events.

The system 102 is also configured to operate in a target time mode. When a timer nears a target elapsed time (e.g., an elapsed number of seconds), a feedback technique associated with this mode communicates the elapsed time for a given number of seconds (e.g. for 3 or 4 seconds on either side of the target time). The target time is user configured or part of a workout plan. If the target time is manually configured, a default target time is used when this mode is entered, but the user can also manually adjust the time to his/her desired target time. For example, the target time resets when the system 102 detects the physical movement of a stop swimming event and a subsequent start swimming event. Optionally, the user manually resets the target time to zero. In this mode, the target time alternatively serves as the swimming performance measure corresponding with this mode of operation. Further, the optional sensors 224, 226, 228, 230 associated with this mode are selected to detect the swimming events that may be subject to a target time.

In certain swimming strokes it is optimal to minimize up and down body movement relative to the surface of the water because it adds drag and does not serve to create propulsion. Many swimmers who excessively “bob” in the water are not aware of this tendency. In an up and down body movement stroke technique evaluation and improvement mode, when the determined physical activity is a type of swimming activity the system 102 provides the user feedback on the “amount” of the physical movement of bobbing while swimming. Some up and down movement always naturally exists, but coaches and swimmers want to eliminate extremes, so a sensitivity setting can be used to dial in detection sensitivity (e.g. a feedback announcement given for a little bobbing or a lot—i.e. high amplitude). The optional sensors 224, 226, 228, 230 selected for this mode illustratively include those that are more sensitive to up and down motion (e.g., pressure sensor 224, gyroscopic sensor 226). The feedback technique is in the form of a tone which increases/decreases in volume and/or pitch as the amount of detected increases/decreases. The magnitude of bobbing illustratively serves as a performance measure. A sensitivity setting is user configured or part of a workout plan.

The system 102 is also configured to operate in a head/body position or head/body motion stroke technique evaluation and improvement mode during a swimming activity. In swimming the body follows movement of the head and therefore any misalignment of the head with the body or tilting of the head can cause stroke technique issues such as increasing frontal drag forces. Additionally poor body position or under or over rotation can cause stroke technique issues. The optional sensors 224, 226, 228, 230 selected for this mode of operation illustratively include those that are more sensitive to physical movement associated with improper head/body positioning (e.g., accelerometer 222, gyroscopic sensor 226). The system 102 communicates the performance measure of whether the user's head or body is aligned properly for the performed stroke type via the feedback technique (e.g., a feedback announcement). A sensitivity setting is optionally used to dial in how sensitive the detection will be to misalignment (e.g. feedback announcement given for a little misalignment vs. a lot). The feedback technique is illustratively in the form of a tone that increases in volume and/or pitch as the amount of detected misalignment increases. The sensitivity setting is user configured or part of a workout plan.

A workout management mode of operation, is based on workout plans stored on the system 102 (e.g., in the memory component 206). For a swimming activity, the system 102 detects physical movement associated with the current set and repeat (i.e., a count of the number of repetitions of a plurality of intervals or segments the user is performing) of the workout plan, for example by tracking the activity performed and comparing the detected activity to a selected workout plan the user is currently executing. The system 102 provides the user with feedback announcements of the particular repeat that the user should perform next, detailing what the user should do and/or communicating to the user a reminder of the goal or intention of the set. The repeat and/or the goal reminder illustratively serve as the performance measure of this mode. In lieu of an automatically generated audio feedback announcement, the user presses a button to hear an audio feedback announcement of the number of the performed repeats or the repeat to be performed next. The system 102 optionally provides the user with feedback announcements of when to start swimming based on the rest interval for the repeat. The system 102 is configured to provide a countdown before the sendoff. The optional sensors 224, 226, 228 230 are alternatively selected based on the swimming events in the executed workout plan.

In a settable alert mode, the associated feedback technique is an alert that is communicated at regular intervals. What triggers the alert is alternatively based on the performance measure of a timed period, a distance swum, or a number of lengths swam. The alert trigger, timer value, the distance swum value and/or the number of lengths swum is user configured or derived from a workout plan. Users can manually start, stop, and reset the timer.

The system 102 also operates in an automatically reset count-up mode of operation. In this mode of operation, the associated feedback technique includes elapsed time communicated to the user at an interval based on a reporting rate. The processor 204 starts one or more of the timers 214, for example, to track the elapsed time. The reporting rate (e.g., performance measure) is user configured or is part of a workout plan. As the user exercises, the timer 214 resets to zero in response to detecting the physical movement of a swimming event. The reporting rate, in one example, is user configured or is part of a workout plan. The user is also able to manually the reset the elapsed time.

The system 102 is also configured to operate in a continuous count up mode. In this mode, a number of seconds of elapsed time (i.e., the performance measure) is the feedback technique used communicate to the user an interval based on a reporting rate (e.g. once per second). Alternatively, the elapsed time is communicated at regular intervals (e.g., every 5 seconds). The reporting rate is user configured or part of a workout plan. The user optionally manually starts, stops, and/or resets the elapsed time.

In a stroke cadence mode, the system 102 provides an associated feedback technique (e.g., a feedback announcement of a beeping sound) at a given interval (e.g., the performance measure) that can be used by the swimmer to maintain a target stroke cadence. The target cadence rate for this mode of operation is user configured or part of a workout plan. If the target cadence rate is manually selected, a pre-configured cadence rate is optionally used as a default when the mode is entered, and users manually adjust the time to their desired target cadence rate. Stroke cadence may be paused while announcing performance measures or while the swimmer has stopped in order to give priority to these other announcements. The stroke cadence rate can be configured to be different per length based on user configuration for a particular mode of operation or based on information in a workout plan. Additionally, cadence announcements can be configured to only be given for a configurable duration after a start and/or turn event is detected. This period is known as the “breakout” time in swimming and the cadence can be useful, for example, for timing dolphin kicks during the breakout or maintaining the breakout for a certain period of time.

Another mode of operation is cadence/speed test mode. In this mode, the device 102 cycles through different cadence rates and captures and records the swimming time for a given distance in order to determine the optimal tempo for a given swimmer to use in order to maximize his/her speed. The cadence, which serves as a performance measure in this mode, is communicated as an associated feedback technique (e.g., a feedback announcement of a beeping sound). The target cadence rates are user configured or part of a workout plan. The device is able to vary the cadence rate over a set of rates (faster and slower) throughout the course of the test. Additionally, the user can input their perceived level of exertion or an external heart rate sensor can provide feedback on the user's exertion level in order to determine the optimal cadence rate for the user.

In one example scenario, the selected mode of operation is constructed from a combination of multiple modes of operation. For example, the stroke cadence mode can be combined with swim performance statistics mode during a particular type of workout or set. The system 102 is configured to store various metrics (split times, time to complete a segment, time to complete interval, stroke count, etc.) as the user completes various workout plans and as the device 102 transitions through various modes of operation. At some point, the user may want to download the stored metrics to the electronic device 104 or the computing device 106 to view the stored metrics.

As part of downloading statistics to one of the devices 104, 106, the user launches an application (app) running on the electronic device 104 or the computing device 106. In one embodiment, if the user is not already logged into the application on their device 104, 106, the user logs into the application via a standard means (e.g. username and password, using their Facebook, Twitter, Google, etc. account, etc.). First time users must register in order to setup their account. After users are logged in, they can select whether they want to plan their upcoming workouts, view an overview of their workout history, view a completed workout, select a workout to do, view workout statistics, or synchronize with their device. In one example, the app displays the uploaded data in a tabular format for the user to view and edit enabling the user to view and edit the data.

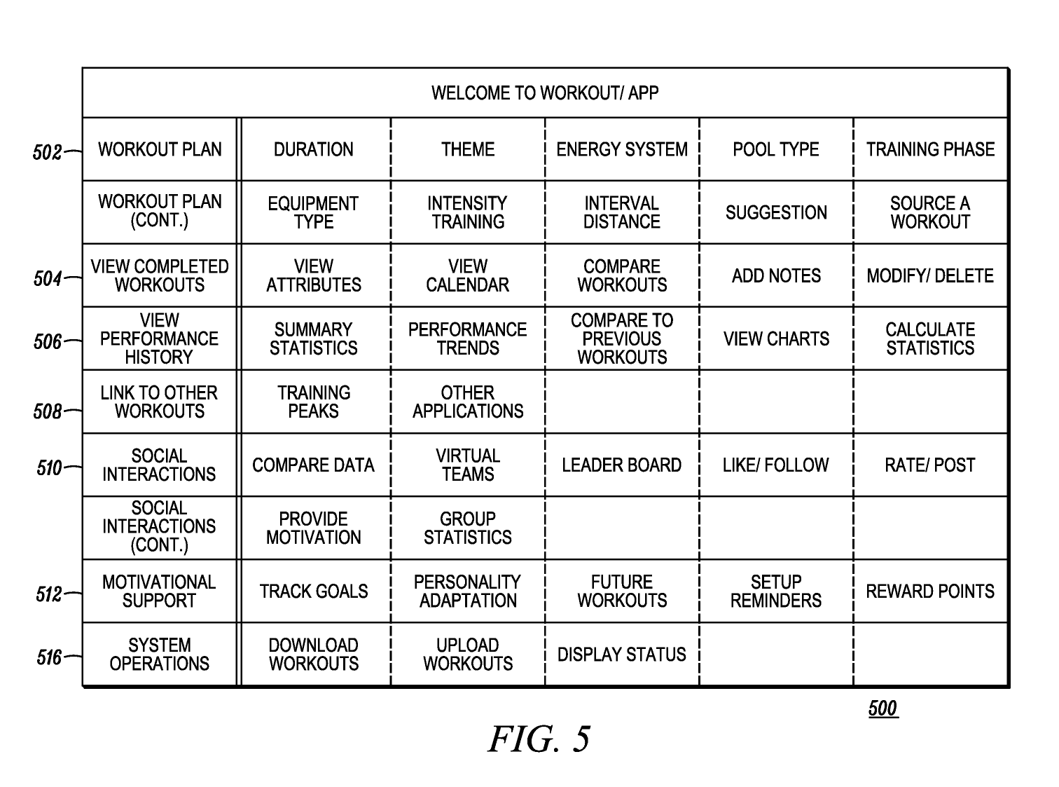

FIG. 5 shows one example of a tabular view of exercise data that is viewable and updatable using an electronic device or computing device in accordance with the present teachings. The table 500 is made up of a number of rows 502, 504, 506, 508, 510, 512, and 514. Each row includes a number of selections for a user to choose from. When a user chooses an entry, the user is provided the opportunity to edit a number of parameters that are downloadable to the system 102. Using the Workout Plan Selection 502, the user can create and view a workout plan that he/she later downloads to the system and uses as a workout plan. Users can plan their upcoming workouts by selecting an existing workout plan or creating a new workout plan. They can then add the workout plan to a list or specify a particular date in the future when they plan to perform the workout, in which case it is placed on the user's workout calendar. For workouts that are placed on their workout calendar, users have the option of synchronizing those dates and times with their personal or work calendars such as Outlook, Google, etc.

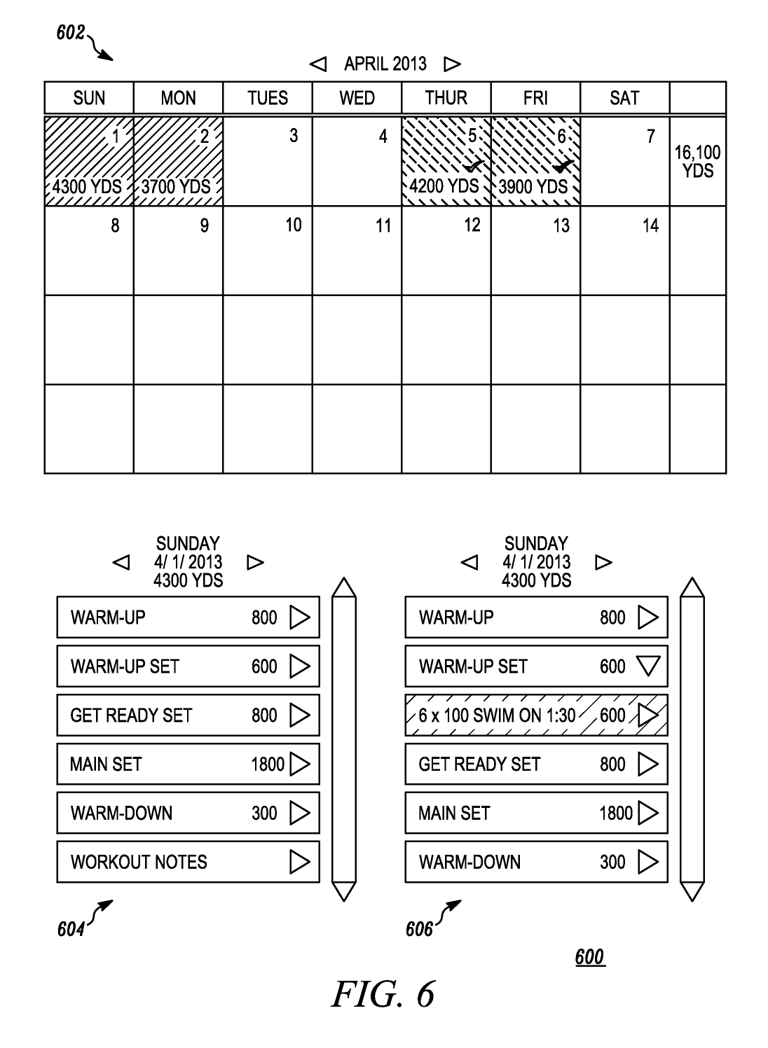

Users can choose a message to display in their personal/work calendar to remind them of upcoming workouts. Some users will want it to be low key (e.g. simply “workout”), other users may want to have more specific information such as the yardage of the work, and others may want more motivational and encouraging reminders. Users have the option of setting up reminders for their workouts. For example, a simple Smartphone reminder could pop up a certain amount of hours before the workout to mentally cue the user and remind them of their upcoming planned workout. As illustrated in FIG. 6, 602, users can view their planned workouts on a calendar view, showing a snapshot of which days workouts are planned and summary information about the workout such as the workout distance, the workout type, and/or workout name.

Returning to FIG. 5, 502, for creating a workout plan, users have access to a database of available workout plans. These workout plans are categorized and ordered based on a number of factors such as the workout duration or distance, the workout type or theme (e.g. sprint, long distance, IM, stroke, etc.), energy system trained (e.g. anaerobic, aerobic, VO2 MAX, etc.), workout intensity rating, the pool type (e.g. short course, long course, etc.), the phase of the training season (e.g. base, overload, taper, etc.), type of equipment used (e.g. kickboard, fins, etc.), the rating of the workout given by other users, the interval distance for the main set (e.g. 200's), etc. Workouts are also organized based on which coach offered them, other users that have completed the workouts, or season-based training plans.

The workout plans are optionally in a list that is sorted by the various attributes. Users select one or more workouts from the list. The workout plan selection can be made by having the user select desired workout attributes (e.g. a 1½ hr distance freestyle workout) and the application randomly selects a workout or list of workouts with those attributes. The user interface for this selection may be via a “spinner” where each attribute is a separate dial that can be spun and, when the combination of attributes are locked in, the random workout or list of matching workouts are selected. In yet another embodiment, users select workouts using the voice interface on the electronic device 104 or other device (e.g., computing device 106 or server 108). For example, users provide a voice request for “a 1 hour sprint workout.”

Workout plans are optionally suggested to users based on a number of criteria. Workout plans can be suggested based on similarity to past workouts selected by the user (e.g. based on the workout attributes described above). Workout plans are illustratively suggested based on the amount of time since a workout similar to the suggested workout has been performed (e.g. to give the user variety), or suggested based on suitability and requirements for a training program being executed by the user.

Workout plans can come from a variety of sources. Coaches can provide workouts for their athletes or more generally for all users. Users can create workouts and share them with other users. Workouts can be based on captured workout data from a user (i.e. the captured data is turned into a workout plan). Workouts can be grouped into a training plan (i.e. a sequence of workouts to achieve a training goal). Training plans can be for different durations, for example, for a season concluding with a championship competition. Training plans can focus on different goals such as improvement of a particular aspect of performance (e.g. speed, particular type of exercise/event, etc.) or can be more general such as lose weight or improve self image.

Workouts may be from “celebrity” users. These workouts can be workouts that have been performed by well known athletes, written by those athletes, or, at a minimum, endorsed by them. There may be a set of “branded” workouts, i.e. workouts that are labeled in a way that allows users to easily identify and select workouts that have characteristics to their liking. This is similar in concept to a radio station that has a particular theme of music (top 40, country, 80's music, etc.). For example, “Smooth Jazz” workouts might be easy workouts that leave the user feeling mellow. “Animal” workouts might contain very difficult challenge sets.

Workouts are adaptable for an individual user based on his/her past workout performance data. For example, rest intervals, number of repeats, and distances can be tailored to the individual. This is useful when users are doing celebrity workouts adaptable to their individual skill level or when comparing a given user's workout results to others. Workouts are creatable with general performance parameters for rest intervals, number of repeats, and distances that are automatically adapted based on user capabilities, past workout performance data, etc. Users can add motivational audio feedback announcements to a workout plan to be communicated to the user at a selected point in the workout (e.g. before the last repeat in a set), or based on a swimming performance measure. Feedback announcements may be recorded by the user, recorded by another user or coach, selected from a list, or can be generated using text to speech. Additionally, a user could configure a music playlist as part of a workout plan and the device could play the configured song corresponding to the set or interval being performed.

Additionally, as a feedback technique, a user could associate a music playlist with a workout plan. The system 102 could play a song(s) associated with the set or interval being performed. Alternatively, the system 102 could selects a song or set of songs for playback based on the current mode of operation or based on determined swimmer performance measurements. For example, if the system 102 detects that the swimmer is performing a high intensity activity such as intervals with a short rest duration or swimming at a speed that is near his or her historical maximum, the system could play a song that has a fast tempo or a song that the user has indicated should be used for high intensity activity. Conversely, a slow tempo song could be played during warm-up or cool down.

Users can create their own workout plan. Workout plans can be based on a workout template that outlines the different workout segments (e.g. warm-up, get ready set, main set, etc.) or can be free form. Users can fill in the workout segments with the workout details (sets, repeats, intervals, stroke type, etc.). For each set and/or repeat within a set, users can specify the mode of operation to use. They can also specify when to play audio motivations. The user can specify the workout summary information (name, type, etc.) for the workout plan.

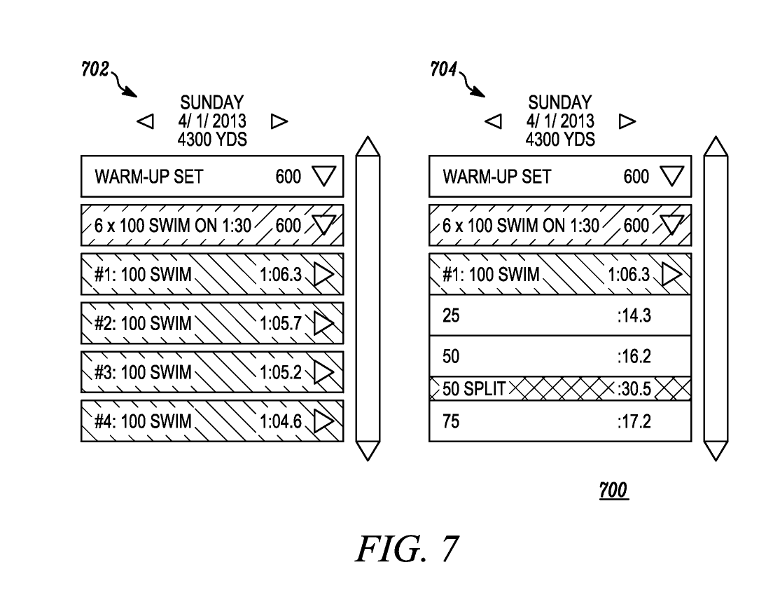

After a user has completed a workout, the user optionally downloads the data associated with the workout to the electronic device 104. When the user selects View Completed Workouts 504, the user is able to view the data associated with past workouts. For example, previous workouts are viewable based on swim attributes (e.g., distance of workout, time, etc.). The workouts can be viewed on the user's workout calendar based on the date when the workout was completed, the workout performance data is displayed in a summarized format with distances displayed associated with each titled workout segment (see FIG. 6, 604). The user is able to select a particular workout segment to see the sets and intervals in the workout (see FIG. 6, 606). The elapsed time for each repeat in a set is available for viewing. (see FIG. 7, 702). When looking at a repeat, the user sees the per-length time and any split times (i.e., combinations of individual length times) (see FIG. 7, 704). The drill-down view 604, 606, 702, 704 of the workout calendar 602 is available to the user to view workout information for any completed workout segment, set, or repeat.

In some examples, the server 110 stores workouts from other athletes that are interested in sharing their information and comparing their results with others. When the user views a completed workout, the user is able to compare workouts that he/she performed with workouts that others have performed. This information is optionally shown in a side-by-side fashion, a table, a graph, or other appropriate format. In some example embodiments, the user is able to add associated workout data. These notes are, for example, free form notes that the user types in, or the user may answer a set of questions about the workout (e.g. how they felt during the workout, if they liked the workout, a workout rating, if they would like the next workout to be harder, easier, the same, etc.). Also, the user is able to delete a completed workout if he/she no longer desires to retain the workout information.

Different activities during a typical workout may produce different sensor data characteristics. Having information about what activity is likely being performed by tracking against a workout plan or mode can provide information used to specify or adjust detection algorithm parameters in order to produce more accurate results. The above detection and monitoring algorithms describe the use of detection thresholds and time windowed data analysis (e.g. rolling averages, variance calculated over a number of samples, etc.). In one embodiment, detection thresholds and time windows or timers are specified based on the workout activity being performed. For example, during warm-up and cool down sets, swimmers will often stop in the middle of the pool to stretch, adjust their goggles, etc. The time period used to evaluate a lack of activity and generate a stop event can be extended during warm-up and cool down sets in order to prevent a false detection of a stop event.

In one embodiment, thresholds and timers can be specified or adjusted based on a reference “training” session for an individual swimmer. Swimmers can put the system 102 into a learning mode that captures and analyzes the sensor data pattern particular to that swimmer in order to set appropriate thresholds and timers. The system 102 illustratively walks the swimmer through a series of activities such as swimming freestyle or doing a butterfly turn and the system 102 captures and analyzes the sensor data.

Adjustments to default values can be made or new values can be determined in order to provide more accurate detection for the given swimmer. In another embodiment, the system 102 can adapt thresholds and timers based on corrections that the user makes to their uploaded workout data. Using feedback from users, the app can modify the uploaded workout data to correct inconsistencies with their actual swims. These corrections point to a particular event in the workout where changes to the detection parameters would provide more accurate results. For example, if the device missed a turn event or several turn events, an analysis of the captured sensor data can be made at the particular time of the missed turn event to determine new thresholds or timers that would have resulted in the correct event detection.

The selections associated with View Performance History 506 offers the user selections to look more deeply at data associated with workouts. For example, users are able to display summary statistics based on completed workout data. Performance trends are displayed over a user selectable time period for any combination of speed, distance, stroke type, energy system, etc. Statistics are displayable in the form of raw data, line graphs, bar graphs, scatter plots, etc. The user is able to compare workout performance data for a given set or workout to previous times that same set or workout was performed. Workout performance data is viewable in charts (e.g., line charts to view trends over time). The workout application is configured to graphically compare information on like distances, training modes, stroke types, energy systems, etc. The user is able to calculate statistics on time vs. goal times, negative splitting, building, descending, stroke count, stroke count vs. time, distances covered, customized performance metrics, etc.

Selecting Link to Other Workouts 508 allows the user to link to other workout tracking and coaching applications such as TrainingPeaks.com. Additionally, workout data is linkable to other applications including performance data tracking applications that today only track competition performance information (e.g. TeamUnify or MeetMobile).

Users may want to compare their work results with others. In doing so, users are able to gauge their workouts with others also involved in similar types of workouts. When the user selects Social Interactions 510, a number of options are available for the user to compare his/her workout performance with data of others that have completed the same workout. Workout performance data is comparable per set/interval or can be an overall workout performance metric. An overall workout performance metric can be calculated by comparing the captured workout data to a baseline such as a user's past performance data, normalized workout data, or a database of others. Comparisons to other users can be made based on adjusted times, distances, resistances, etc. in order to “level the playing field.” Adjustments can be made to normalize times based on users' best times, times on a test set, age, height, weight, or other factors or by using other standard data normalization techniques. This may be particularly useful when doing a celebrity workout, allowing the user to compare themselves to the celebrity.

“Virtual teams” can be setup to group users together. Virtual teams can have a customized portal where all users that are part of that team see the same home screen and content when they log in. Virtual teams can have private leader boards (described below), comment board, workouts, ability to follow others on their team, etc. Virtual teams can compete against each other in virtual competitions, for example, based on the number of workouts completed in a given time period, distance completed in a given time period, performance on a challenge set, comparison of customized performance metrics, etc.

A leader board can be setup to compare workout performance statistics, customized performance metrics, or performances on a particular set or interval against others. Leader boards can be private where users invite their circle of friends, public, or the leader board is based on a defined community of interest (e.g. a particular team, region, etc.). Metrics used for comparison purposes on leader boards could be based on adjusted or normalized data as described above.

Users can select other users to “follow”, where the followed user's workout data, completed workouts, and future workout plans are viewable by followers on a permission basis. Users can configure whether they want to allow anyone to follow them, only accept followers based on explicitly granted permission, or to allow followers from a particular community of interest (e.g. a particular team, region, etc.). Users can configure whether their followers can see their workout data, completed workouts, and/or future workout plans. Users can “Like” workout plans in the workout plan database, where the number of likes are tracked and can be used to rank workout plans in a list. Users can rate workouts, for example, with a number of stars. Ratings can be used to rank workout plans in a list.

Users can post their workout summary data or general workout information to their social media accounts, and they can provide audio motivation announcements for other users which can be included in that user's workout plan. These motivational announcements can be downloaded to their device and played at the appropriate point during their workout. Introductions to other users are possibly based on a number of parameters including preferences for similar workout characteristics, selection of the same workout some percentage of the time, similar performance capabilities, geographical proximity, etc. Permissions for user introductions are configurable by the user. Initial introductions may be anonymous with actual identities only revealed given mutual user consent.

Users can compare themselves to others based on anonymized group statistics. Groups can be created based on age, region, virtual team, performance capabilities, similar workout preference, etc. Comparison can be made based on a number of workouts completed in a given time period, distance completed in a given time period, performance on a challenge set, comparison of customized performance metrics, etc. For example, users may be told “others in your age group do x yards per week . . . ”, or “for your virtual team the average time on the last interval in this set is 2:02.”

The motivational Support 512 selection assists user in tracking and remembering to plan and execute their workouts. Goals can be in the form of specific performance measurements the user wants to achieve (e.g. time, distance achieved over a period of time, etc.), specific weight or health goals, or more general goals such as feel better about one's self, improve one's self image, etc. Input goals can be used as an occasional reminder to the user. In one embodiment, the goal may be displayed on the user's calendar of workout plans (e.g. a general reminder or in another example a display of the number of days until a goal competition, for example, a championship meet). In another embodiment, the goal is used as an audio announcement provided to the user while they are executing a workout (e.g. “this set will give you finish speed in your 200 free to help you to break 1:36”).

User's personality can be used to adapt the user experience and interaction with the app in order to better match a user's preferences or be more effective at motivating the user. Adaptation of user experience can include, the wording of feedback, suggestions, sayings, etc. (e.g. assertive vs. passive, terse vs. verbose). Adaptions also include how often feedback and suggestions are given (e.g. more frequently for people who do better with reminders), and the look and feel of the app/web site including fonts, colors, pictures, images, video clips, etc. (e.g. bolder colors or bigger fonts for more assertive or outgoing personalities). In another embodiment, font colors, font types, pictures, images, etc. are selectable based on similarity to the user's school colors (e.g. their undergraduate or most recent college). User experience adaptations can extend to other communications with the user as well such as emails, advertisements, etc.

The ability to plan out future workouts, check them off when completed, download planned workouts to the device and schedule them on personal/work calendars all have motivational aspects for the user. Users can plan their upcoming workouts when their motivation is high (e.g. coming off the weekend when they are better rested) and execute on those plans when their motivation is lower (e.g. at the end of a hard week of work, school, workouts, etc.) increasing the likelihood that the workouts will actually be performed (this effect is described by Stanford researcher B J Fogg). Additionally, checking them off as they are completed provides a sense of accomplishment. Downloading multiple workouts to the device in advance can provide motivation to users. By knowing that the workouts are there and ready to go, the device becomes a physical reminder of the commitment to do the workouts.

Having a workout plan that spans several workouts where the individual workouts work together to achieve a more general training effect can provide motivation. For example, missing the middle workout in a set of three grouped workouts makes it more difficult to pick up the third, thereby providing motivation to not miss the second one. These grouped workouts can contain specific training objectives that bridge into the next workout (e.g. a long workout on the first day to fatigue the user which sets up the next training session to work hard when fatigued). Alternatively the workouts simply provide sufficient variety (e.g. not doing distance workouts two days in a row). Integrating with personal/work calendars provides psychological motivation by allowing the user to see the workout on their schedule as something that they have committed to do and they have reserved a particular time to do it. Psychological studies show that committing to a specific plan of action increases the chances that the user will actually carry out the action. Additionally, blocking out the time to do the workout increases the probability that time will actually be available to workout and not get committed to other activities.

Users can setup reminders and display motivational reminders on the app. Users have the option of setting up reminders for upcoming workouts that are displayed as alerts. For example, a simple Smartphone reminder could pop up a certain amount of hours before the workout to mentally cue the user and remind them of their upcoming planned workout. Additionally, information on past workouts or a summary of past workout information is displayable to the user as part of the reminder. Users can configure how they would like to be alerted and the content of the alerts (e.g. distance completed over a period of time such as a week, number of workouts completed, customized performance metrics, etc.). The alert frequency and content can be dictated by the personality profile mentioned above (e.g. alert more often for more outgoing or assertive people). In various alternate embodiments the motivational reminders can be displayed in special Smartphone alert and message center spaces, on a paired smart watch (e.g. the Pebble), in a web browser widget, in a desktop widget, sent via email or text message, or posted on a social media site (e.g. Facebook). Reminders may also contain references or comparisons to the user's goals, the performance of others (e.g. virtual team stats), etc.

Users can earn reward points based on their various workout activities. These reward points can be tracked and used towards free merchandise or discounts from sponsors which can function as a motivator for users and as a direct advertising mechanism for retailers. Points are earned when the user performs a workout. Extra points can be awarded for achieving pre-set goals, doing all of the planned workouts in a week, doing a certain amount of distance in a given period of time or accumulated distance, etc. Users can view their point totals, compare them to others, etc. Additionally, challenges can be offered which upon completion the user receives a specified number of reward points. Examples of challenges might be completing a series of specific workouts, completing certain time or distance goals, being on top of a leader board, etc. Challenges where comparisons are made to other users can be made based on normalized times, distances, etc. as described above. In one embodiment, retailers can offer the challenges as a means of advertising to potential customers. Multiple retailers can offer merchandise, discounts, or advertising to users with certain retailer's ads being given priority for a given user (e.g. more prominent placement on the screen, etc.). Using a mapping between the unique device identifier which uniquely identifies the system 102 and the retailer that sold the device ad priority can be given to the retailer that sold the device, thereby creating incentive for the retailer sell the device.

With the System Operations 516 selection the user is able to set configuration and update parameters of the system 102. For example, when the system 102 is paired with either of the devices 104, 106 (e.g. using Bluetooth) and ready to communicate, users are able to download one or more workout plans to the system 102. The user selects ahead of time which workout plans to download (e.g., via the calendar view) or the user is prompted to choose from a list of selected workout plans. After transferred to the system 102, workout plans are stored in the system 102 and are ready for execution. When the system 102 is paired with the electronic device 104 and ready to communicate, the user can upload completed workout data from the system 102 to the device 104, 106. The app will show the user which workout data is available to upload from the system 102 and shows the user which workout data has already been uploaded.

The app and web site implementation includes a back-end database (e.g., database 108) that is used to store workout plans, user account information, and users' completed workout data. The workout plans, user account information, and stored workout data are viewable via the app or via a web site. Various views are offered of the information including a calendar view to show a summary of completed workouts and a view of planned upcoming workouts. Clicking on a completed workout on the calendar view shows the workout plan and the captured workout data. Clicking on an upcoming workout shows the workout plan, and the time, date, place, etc. where the workout will be performed.

In one example, the website implementation has a substantially similar layout as the table illustrated in FIG. 5. For example, an entry similar to the Workout Plan 502 entry is in the website implementation. This entry includes selectable items related to workout plan selection. When a workout plan is selected, the user is able to adapt the workout plan to his/her own performance level. Workout plans in the database specify general performance parameters for rest intervals, number of repeats, and distances along with an intended intensity level. Users' past workout performance data can be used to adapt the rest intervals, number of repeats, and distances to a suitable level of performance and challenge for the user. Adaptation can be based on a user's past performance on a similar set, baseline performance on a test set, or overall performance categorization (self selected or determined over time from workout data). Alternatively, an overall intensity level for the workout can be specified which adapts all sets and intervals based on the general intensity parameter. Users can create their own workout plans.

The server 108 provides hints or suggestions to users of sets to do, number of repeats, or intervals to select. Suggestions for distances, intervals, resistance, etc. are optionally based on the user's personal performance history as described above. Workout plans that users create can be run through a workout checker. The checker can check to assure that users have included workout elements such as a proper warm-up and cool-down. The checker can also calculate the total time and distance for the workout and verify that the workout fits in the scheduled workout time. Further, the checker is able to verify that the interval times and distances create a workout that meets the energy zone targets and/or set or workout intensity targets based on the user's past performance data.

Workout plans can specify the system 102 mode of operation for specific sets or intervals within a set (e.g. turn on cadence mode at the end of an interval or turn off performance mode during warm-up and cool-down). For a particular mode of operation, the workout plan specifies specific parameters to use to configure the device mode (e.g. set performance mode to communicate the user's time every 50 on a 400 instead of every 100). “Workout level of intensity” custom performance metric includes a calculation that can be performed to quantify the level of intensity of a workout based on the total distance of the workout, effort level required, rest intervals, etc. The custom metric also includes a level of intensity that can be personalized where intervals are compared to the user's past performance results (generally lower rest equals higher intensity). Additionally how the intervals are to be performed (i.e. fast, hard, etc.) is considered. Weight or resistance used could also be considered. Lastly distance or number of repetitions can be considered (e.g. more equals higher intensity).

Workout history information akin to that found in FIG. 5, View Completed Workouts 504, includes captured and stored workout data that can be viewed using traditional data analysis tools such as tabular format, graphs, charts, etc. Traditional statistical analysis which can be used to chart and project progress, compare current performance to past performance, etc.

Social interactions are also part of the website implementation. For example, users can be “matched” to other users via a matching algorithm that determines a strength of similarity that indicates an interest for the users to become aware of one another. Strength of similarity is determined by comparison of references for the same workout characteristics such as workout type, workout distance, workout intensity, etc. (e.g. both users like distance workouts). Strength of similarity is also determined by selection of the same workout plan some percentage of the time, and similar performance capabilities such as times for a particular interval or set, resistances, weights, custom performance metrics, etc. Performance capabilities should be within a configured amount of difference. Geographical proximity and other captured workout data or workout characteristics can also be factored into the strength of similarity.

Personality information used to adapt the user experience can be gathered from a number of different sources. The user's personality is illustratively derived by mining their social media profiles (e.g. Facebook or Twitter) to determine broad personality traits. Personality tests are administered, for example, as part of registering for the app/web site. Optionally, the user's age serves as a proxy for their broad personality traits.

Workout plans can be adjusted from a baseline workout plan to account for an individual user's capabilities or preferences or to adjust to a user's past performance or current physical or mental state (e.g. tired). Adjustments can be made to the duration or distance of the workout, the number of intervals in a set, the number of sets, rest intervals, required effort, etc. Workout plans can be configured with target intervals or target rest for particular performance categories of users. Based on the performance category of the user, an appropriate adjustment to the rest interval is possible. Users can be tracked into one of a number of performance categories based on, for example, a time or average time on a test set, an average time for a particular distance as performed in previous workouts, or a fastest or best time.

Workout plans are configurable with a target amount of rest for a given interval and an actual interval for a given user can be generated based on the user's time or average time on a test set, an average time for a particular distance as performed in previous workouts, a fastest or best time, or the user's performance or average performance on the same distance in previous workouts. Adjustments can be made based on a user's performance on a same or similar set or interval in a past workout (e.g. the user made it, didn't make it, barely made it but it was supposed to be easy, etc.).

In one embodiment, the user can specify for a particular interval, set, or workout if it was too easy, too hard, just right, etc. Adjustments can be made to the amount of rest, number of intervals, etc. based on the intensity of a recently performed workout (e.g. give an easy workout after a very intense workout). Adjustments can be made to the amount of rest, number of intervals, etc. based on information gathered from a user's workout notes for past workouts or from workout interview data collected in association with the workout. For example, if the user indicates that they are “tired” the intensity of the next workout could be reduced. In another example, if the user indicates that the workout was hard or challenging and it was meant to be moderate or easy, then the amount of rest for future workouts can be calibrated accordingly.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus.

An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically.

A device or structure that is “configured” in a certain way is configured in at least that way, but may also be configured in ways that are not listed. As used herein, the terms “configured to”, “configured with”, “arranged to”, “arranged with”, “capable of” and any like or similar terms mean that hardware elements of the device or structure are at least physically arranged, connected, and or coupled to enable the device or structure to function as intended.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method, implemented by a wearable performance measurement system, for determining and communicating a performance measure, the method comprising:
selecting a mode of operation of the wearable performance measurement system from a plurality of configured modes of operations, wherein each mode of operation of the plurality of configured modes of operation has a corresponding configured performance measure and configured feedback technique, and at least one of the configured performance measure or the configured feedback technique is different for each mode of operation;
detecting, using a set of sensors of the wearable performance measurement system, at least one physical movement of a person;
determining a type of physical activity from the at least one detected physical movement;
determining the performance measure corresponding to the selected mode of operation, wherein the determining is based on the at least one detected physical movement and the type of physical activity;
communicating an indication of the determined performance measure using the feedback technique corresponding to the selected mode of operation.

2. The method of claim 1 further comprising selecting the set of sensors for detecting the at least one physical movement based on the selected mode of operation.

3. The method of claim 1 further comprising selecting or modifying a set of algorithms based on the selected mode of operation, wherein the performance measure is determined and the detecting is performed using the set of algorithms.

4. The method of claim 1, wherein the mode of operation is selected based on manual input received into an input component of the wearable performance measurement system.

5. The method of claim 1 further comprising communicating the indication of the performance measure before a physical activity session that includes the at least one physical movement has terminated.

6. The method of claim 1, wherein the mode of operation is automatically selected based on a workout plan.

7. The method of claim 6, wherein the workout plan comprises a plurality of segments, and the selecting the mode of operation, the detecting the at least one physical movement, the determining the type of physical activity, the determining the performance measure, and the communicating the indication of the performance measure is correspondingly performed for multiple segments of the plurality of segments.

8. The method of claim 7, wherein selecting the mode of operation for the multiple segments of the plurality of segments comprises selecting a first mode of operation for a first segment and selecting a different second mode of operation for a second segment.

9. The method of claim 7 further comprising communicating an indication of a beginning of at least some of the segments of the workout plan.

10. The method of claim 1, wherein the feedback technique comprises an audio feedback technique.

11. The method of claim 10, wherein the audio feedback technique comprises a feedback announcement.

12. The method of claim 11, wherein the feedback announcement is determined based on the selected mode of operation.

13. The method of claim 1, wherein determining the type physical activity comprises detecting a type of swimming activity, and determining the performance measure comprises determining a swimming performance measure based on the swimming activity.

14. The method of claim 1, wherein the selected mode of operation comprises a combination of multiple modes of operation.

15. The method of claim 1, wherein the selecting the mode of operation, the detecting the at least one physical movement, the determining the type of physical activity, the determining the performance measure, and the communicating the indication of the performance measure is performed multiple times over a time period during a same physical activity session, wherein at least two different modes of operation are selected during the time period.

16. A wearable performance measurement system for determining and communicating a performance measure, the wearable performance measurement system comprising:
a set of sensors configured to detect at least one physical movement of a person;
a processor coupled to the set of sensors, wherein the processor is configured to:
select a mode of operation of the wearable performance measurement system from a plurality of configured modes of operations, wherein each mode of operation of the plurality of configured modes of operation has a corresponding configured performance measure and configured feedback technique, and at least one of the configured performance measure or the configured feedback technique is different for each mode of operation;
receive, from the set of sensors, an indication of the at least one detected physical movement;
determine a type of physical activity from the at least one detected physical movement;
determine the performance measure corresponding to the selected mode of operation, wherein the determining is based on the at least one detected physical movement and the type of physical activity; and
an output component coupled to the processor, wherein the output component is configured to communicate an indication of the performance measure using the feedback technique corresponding to the selected mode of operation, wherein the selecting the mode of operation, the detecting the at least one physical movement, the determining the type of physical activity, the determining the performance measure, and the communicating the indication of the performance measure is performed multiple times over a time period during a same physical activity session, wherein at least two different modes of operation are selected during the time period.

17. The wearable performance measurement system of claim 16 further comprising a housing that contains the set of sensors, the processor, and the output component, wherein the housing is configured to be worn by the person.

18. The wearable performance measurement system of claim 17, wherein the processor is configured to determine a type of swimming activity from the at least one physical movement, and the processor is further configured to determine the performance measure as a swimming performance measure based on the swimming activity.

19. The wearable performance measurement system of claim 16, wherein the feedback technique comprises a feedback announcement, and the output component comprises an audio output component configured to communicate the indication of the performance measure using the feedback announcement.

20. The wearable performance measurement system of claim 16 further comprising at least one of:
an input component coupled to the processor and configured to receive a user input for selecting the mode of operation from the plurality of configured modes of operation; or
a memory component coupled to the processor and configured to store a workout plan used for automatically selecting the mode of operation from the plurality of configured modes of operation.
